(19) United States
(12) Patent Application Publication
(10) Pub. No.: US 2016/0132799 A1
(43) Pub. Date: May 12, 2016

(54) LIST HYGIENE TOOL

(71) Applicant: SMARTFOCUS HOLDINGS LIMITED, London (GB)

(72) Inventors: Jean-Yves Simon, London, England (GB); Charles Wells, London, England (GB)

(73) Assignee: Smartfocus Holdings Limited, London (GB)

(21) Appl. No.: 14/894,812

(22) PCT Filed: May 30, 2014
(86) PCT No.: PCT/GB2014/051667

§ 371 Date: Nov. 30, 2015

Related U.S. Application Data
(63) Continuation of application No. 13/907,501, filed on May 31, 2013, now abandoned.

(51) Int. Cl. G06Q 10/06; G06Q 30/02

(52) U.S. Cl. CPC G06Q 10/0635; G06Q 30/0277

(57) ABSTRACT

A computer-implemented method of assessing the veracity of a list of email addresses for use with an e-mail messaging campaign is described. The method comprises: receiving the list of email addresses; categorising and marking any email addresses from the received list of email addresses which are considered to have predetermined email address problems; each marked email address being assigned a category of problem; associating each marked email address with a score, wherein the score is dependent on the severity of risk associated with the assigned category; calculating a cumulative score of all of the marked email addresses; and determining, in view of the cumulative score of the marked email addresses, whether the list of email addresses is safe for use for the email messaging campaign.

### FIELD OF THE INVENTION

The present invention is directed to a list hygiene tool for and a method of assessing the veracity of a list of email addresses for use with an email messaging campaign. The identification of email addresses which are likely to cause problems when used in an email campaign before the sending of that campaign can advantageously provide greater efficiencies in the execution of that email campaign which is particularly important when implemented for large email campaigns comprising more than 100,000 email messages.

### BACKGROUND TO THE INVENTION

E-mail marketing is a new form of marketing, which is currently dominating the campaigning world. E-mail campaigning is becoming increasingly popular as it is substantially cheaper and faster than traditional mail, mainly because of the costs associated with producing, printing and mailing in traditional mail campaigns. In addition to this, an exact return on investment can be estimated, and has proven to be high when the campaign has been carried out properly. However, e-mail deliverability is still a major issue in e-mail marketing, and the method's Achilles' heel. According to recent reports, legitimate e-mail servers average a delivery rate of just over 50%.

The main reason behind the low deliverability rate is poor e-mail list hygiene. The term “e-mail list hygiene” is used to describe the process of maintaining a list of valid e-mail addresses called an e-mail subscriber list, and involves maintenance tasks such as taking care of unsubscribe requests, removing e-mail addresses that bounce, and updating user e-mail addresses.

Without sufficient list hygiene there is a high risk of damaging sender reputation which can result in having e-mails blocked by Internet Service Providers or violating the anti-spamming legislation currently in place. Furthermore, good list hygiene also has financial attributes, as keeping a list with duplicate e-mail addresses and having to manage a high volume of bounces increases processing power and traffic requirements.

It is desired to provide a method and system which can improve current e-mail list hygiene and thereby provide the benefit of high e-mail delivery ratios.

### SUMMARY OF THE INVENTION

According to one aspect of the present invention there is provided a computer-implemented method of assessing the veracity of a list of email addresses for use with an e-mail messaging campaign, the method comprising: receiving the list of email addresses; categorising and marking any email addresses from the received list of email addresses which are considered to have predetermined email address problems; each marked email address being assigned a category of problem; associating each marked email address with a score, wherein the score is dependent on the severity of risk associated with the assigned category; calculating a cumulative score of all of the marked email addresses; determining, in view of the cumulative score of the marked email addresses, whether the list of email addresses is safe for use for the email messaging campaign.

The embodiments of the present invention are scalable and thus the receiving step can comprise uploading of a large list of email addresses in excess of 10,000 email addresses for a single campaign.

The categorising and marking step may comprise selecting an analysis group of email addresses from a plurality of email addresses provided in the list of email addresses. In one embodiment, the selecting step comprises selecting a subset of the email addresses provided in the list of email addresses. Furthermore advantageously the method may further comprise ordering the selected analysis group of email addresses into alphabetical order.

The categorising and marking step can comprise comparing a composition of each email in the selected analysis group against one or more composition patterns associated with a risky email address and marking the email if the composition of the email address matches a known risky composition pattern.

The comparing step may comprise using a plurality of different risky pattern detection filters. In an embodiment of the present invention at least one of the risky pattern detection filters is selected from the group comprising a spammy pattern detection filter, a spam trap address filter, a malicious email address filter, a sender's own spam trap filter, a non-legitimate email address filter, an ISP complaints from feedback loop filter, a harvested by spammers filter, an unsubscribe list filter, an international suppression list filter and a risky historical behaviour filter.

Preferably each filter comprises a pattern list of email address patterns and the comparing step comprises comparing each email address of the selected analysis group against the email address patterns of the pattern list for an exact match. In an embodiment the email address patterns of the pattern list are stored in alphabetical order and the email addresses of the analysis group are stored in alphabetical order and the method further comprises comparing an email address of the analysis group from a start pointer within the pattern list until an end email address pattern is reached which is beyond the alphabetical value of the email address being compared.

The method may further comprise moving the start pointer of the pattern list to the email address pattern preceding the end email address pattern and repeating the comparing step for the next email address of the analysis group.

The analysis group may also have a current email address pointer and the method may further comprise incrementing the position of this pointer to point to the current email address being considered.

Preferably the categorising and marking step further comprises checking each email address in the analysis group for syntax errors. The checking step may comprise checking each email address of the analysis group for common or obvious errors in the email addresses by comparing the email address against a predetermined list of common and obvious syntactical errors.

The associating step may comprise providing for each category of problem, a corresponding predetermined score, and assigning the corresponding score to each marked email address. In an embodiment the associating step comprises assigning for each category of problem that applies to a marked email address the corresponding predetermined score and storing a cumulative score of all of the applicable predetermined scores. The providing step may comprise providing a score from a group of scores comprising low, medium and high scores.

The associating step may comprise determining whether the marked email address has one of the problems of the group comprising a spam trap address, a spammy domain, a role abuse address, a non-existing ISP address, a ISP RCE restricted address, a spammy pattern address, a role marketing address and a fake MX domain address.

The associating step may also comprise providing a subset of the categories of problem with a quarantine flag indicating that the email address should not be used currently in the email messaging campaign and the assigning step may comprise assigning the quarantine flag if marked email address relates to a category of problem from the subset.

The method may further comprise generating a report regarding the email addresses in the list and the associated scores applied to the marked email address and sending the report to a known client address associated with the email messaging campaign.

The determining step may comprise assessing whether the cumulative score of the email address list is within a high or medium score range and if the cumulative score is within the medium or high range, rejecting the entire email address list as unsafe to use for the email messaging campaign.

The method may further comprise assigning unique identifiers to the marked email address list regarding the client, upload instance and the list and storing the list and the identifiers for future use and reference.

The method may further comprise generating a report regarding the email addresses in the list and the associated scores applied to the marked email address and sending the report and the list back to a known client address associated with the email messaging campaign.

The determining step may comprise assessing whether the cumulative score of the email address list is within a high or medium score range and if the cumulative score is not within the medium or high range, accepting the entire email address list as safe to use for the email messaging campaign. If the cumulative score is not within the medium or high range, the method may comprise accepting the entire email address list as safe to use for the email messaging campaign except for any quarantined email addresses having a quarantine flag assigned.

The method may further comprise updating a blacklist of email addresses.

The method may also further comprise assigning an upload identifier to each instance of a received list, assigning a client identifier to identify the owner of the email address list and assigning a campaign identifier to identify each email messaging campaign to which the list belongs.

In an embodiment of the present invention the method further comprises using the identifiers to determine if a current email address list for the same client and the same campaign is received in the receiving step which has a different upload identifier and for this current list calculating differences between the email addresses of the current list and a previous email address list for the same client and campaign.

The categorising and marking step may comprise selecting an analysis group of email addresses as the differences determined in the using step.

According to another aspect of the present invention there is provided a system for assessing the veracity of a list of email addresses for use with an e-mail messaging campaign, the system comprising: an upload module for receiving the list of email addresses; a categorising module for categorising and marking any email addresses from the received list of email addresses which are considered to have predetermined email address problems; each marked email address being assigned a category of problem; a risk assessment module for associating each marked email address with a score, wherein the score is dependent on the severity of risk associated with the assigned category; a scoring engine for calculating a cumulative score of all of the marked email addresses; a processor for determining, in view of the cumulative score of the marked email addresses, whether the list of email addresses is safe for use for the email messaging campaign.

### BRIEF DESCRIPTION OF THE DRAWINGS

In order for the invention to be better understood, reference will be made, by way of example, to the accompanying drawings in which:

FIG. 1 is a schematic diagram of the overall architecture of a global list hygiene tool according to an embodiment of the present invention;

FIG. 2 is a flowchart illustrating a method of operation of the system of FIG. 1;

FIG. 3 is a schematic diagram showing the architecture of the Categorisation Module of FIG. 1;

FIG. 4 is a schematic diagram showing the architecture of the Risk Assessment Module of FIG. 1;

FIG. 5 is a flow chart illustrating the Categorisation and Risk Assessment procedures of FIG. 2;

FIG. 6 is a flow chart illustrating the Analysis Group Selection procedure of FIG. 5;

FIG. 7 is a flow chart illustrating the Risky Pattern Detection Process of FIG. 5;

FIG. 8 is a flow chart illustrating the e-mail Address Validation Process of FIG. 5;

FIG. 9 is a flow chart illustrating the Scoring Process of FIG. 5; and

FIG. 10 is a flow chart illustrating the process of taking appropriate action of FIG. 2.

### DETAILED DESCRIPTION OF EMBODIMENTS OF THE INVENTION

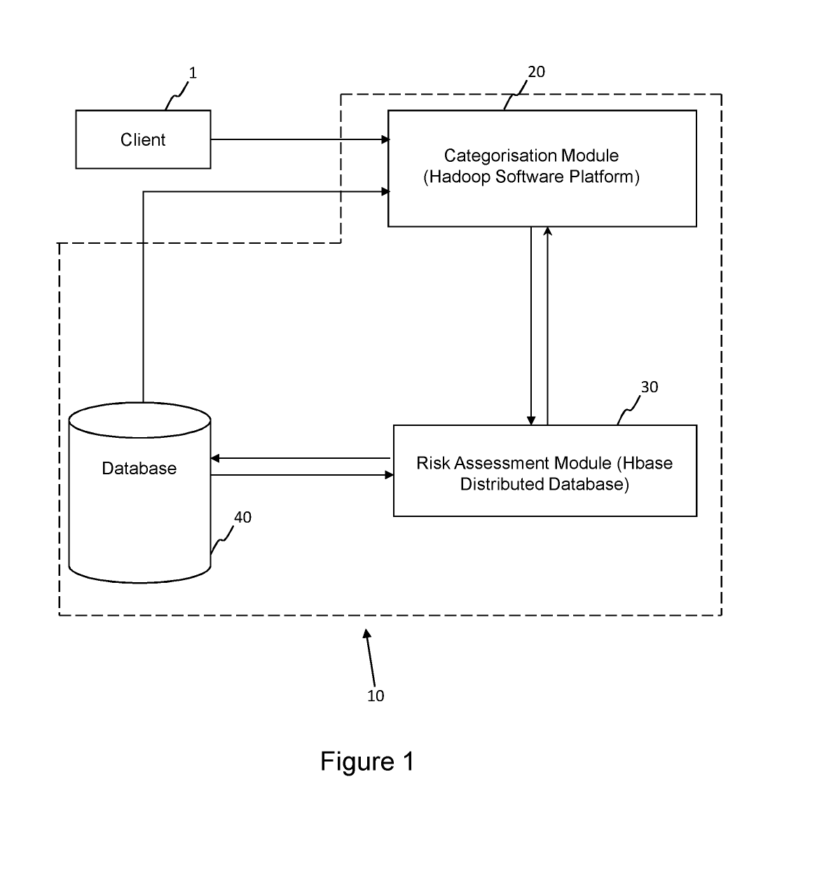

The overall architecture of a global list hygiene tool is now described referring to FIG. 1. In the present embodiment, a client 1 interfaces with the global list hygiene tool 10, which is a computer-implemented function that comprises an e-mail Address Categorisation Module 20, a Risk Assessment Module 30 and a Campaign database 40.

The tool 10 is accessed by a client 1 which can be a piece of computer software or hardware that accesses the service made available by the global list hygiene tool.

The client 1 is connected to the Categorisation Module 20, which is in turn connected to the Risk Assessment Module 30 and the Campaign database 40. The Risk Assessment Module 30 is also connected to the Campaign database 40.

The Categorisation Module 20 is typically an open source software platform, such as Hadoop, used to enable and facilitate the distributed processing of large data sets (in the order of petabytes) across clusters of servers. Hadoop enables applications to work with thousands of computation-independent computers and very large amounts of data, thus speeding up the processing.

The Risk Assessment Module 30 is typically a distributed database, such as Hbase, in which storage devices are not all attached to a common processing unit, but may be stored in multiple computers, or a network of interconnected computers. This parallelism provides scalability and faster data storage and lookup times, which is essential when dealing with such large quantities of data. H Base is an open-source, non-relational distributed database, ideal for providing a fault-tolerant way of storing large quantities of sparse data.

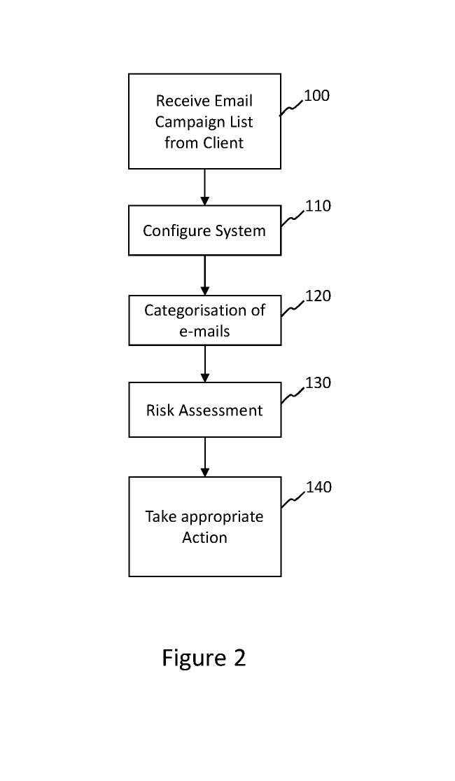

The overview of the list hygiene process according to an embodiment of the present invention is illustrated in FIG. 2.

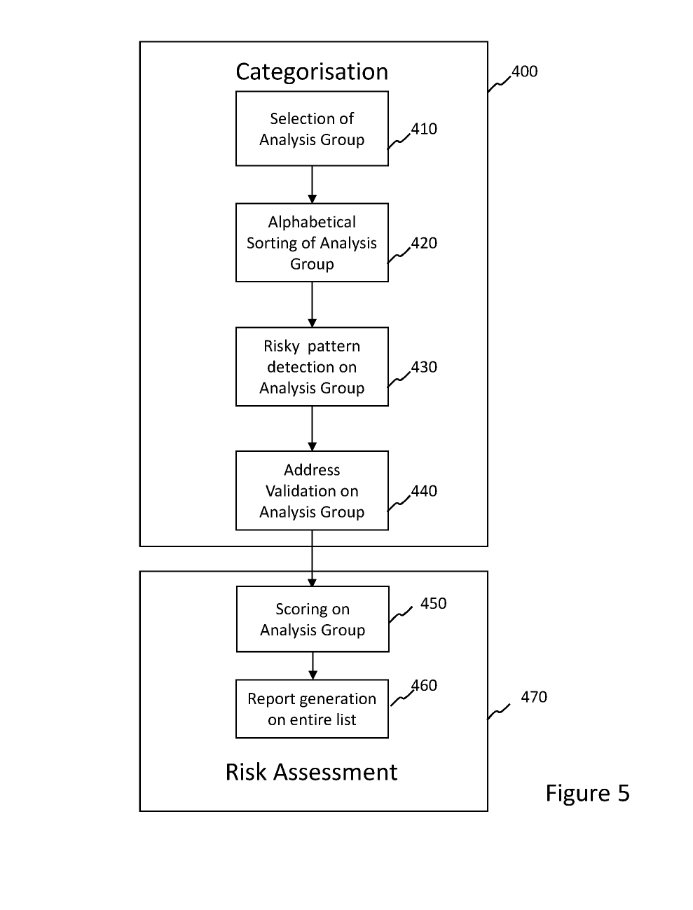

The process begins, at Step 100, when an e-mail campaign list is received. The e-mail campaign list can either be new, or an existing list from a client account stored in the Campaign database 40. The system is then configured, at Step 110, and all updated lists are alphabetically ordered. The e-mail addresses comprising the list are then examined and categorized, at Step 120. As will be explained with more detail below with reference to FIG. 5, during this categorisation procedure of Step 120, any addresses containing possibly problematic patterns are categorized depending on the type of problem that is detected. The list is then passed, at Step 130, through a risk assessment procedure, where the potential risk associated with each category of error is quantified, as will be explained with more detail below with reference to FIG. 5. Once the risk assessment procedure has been completed for each e-mail address in the current e-mail address campaign list, the overall risk associated with the e-mail list is calculated, and an appropriate action is taken, at Step 140, regarding whether the list can be used for an e-mail campaign or not.

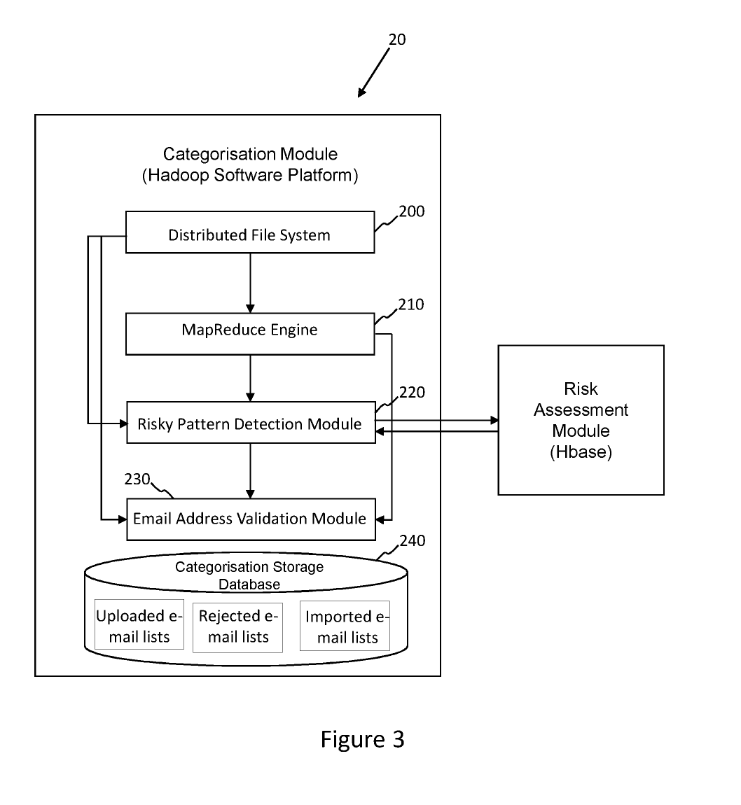

The modules comprising the Categorisation Module 20 according to the present embodiment are depicted in FIG. 3 and described further below. The Categorisation Module 20 comprises a Distributed File System 200, a MapReduce Engine 210, a Risky Pattern Detection Module 220, an E-mail Address Validation Module 230 and a Categorisation Storage Database 240.

The File System 200 in the present embodiment is a distributed, scalable and portable file system which allows access to and storage of files from multiple hosts via a computer network.

The MapReduce Engine 210 functions to process very large data sets, optimal for use in distributed computing, as is the case in the present embodiment. It takes advantage of the locality of data, processing it on or near the storage assets, in order to decrease the transmission of data, and ultimately decrease the workload and computational cost of the processing. The primary function of the Map Reduce Engine 210 is to select the group of data to be analysed and that involves accessing the File System 200.

The Risky Pattern Detection Module 220 examines the e-mail campaign list to detect and flag any e-mail addresses containing patterns that are considered to be risky. The risk in this embodiment is related to the problems that sending e-mail to addresses specified in the list may cause in relation to the completion of the e-mail campaign. The e-mail Address Validation Module 230 examines and flags any e-mail addresses which contain errors, such as obvious or common keying in errors, as these might result in the e-mail not being delivered to that address. The functionality these two modules will be described with more detail below.

The Risky Pattern Detection 220 and e-mail Address Validation 230 Modules are interconnected and they use data provided by the MapReduce Engine 210, as can be seen in FIG. 3. The Risky Pattern Detection Module 220 also sends and receives data from a Blacklist Module of the Risk Assessment Module 30. The Categorisation Storage Module 240 is used to store e-mail lists uploaded from the client, rejected e-mail lists and e-mail lists imported from the Database 40.

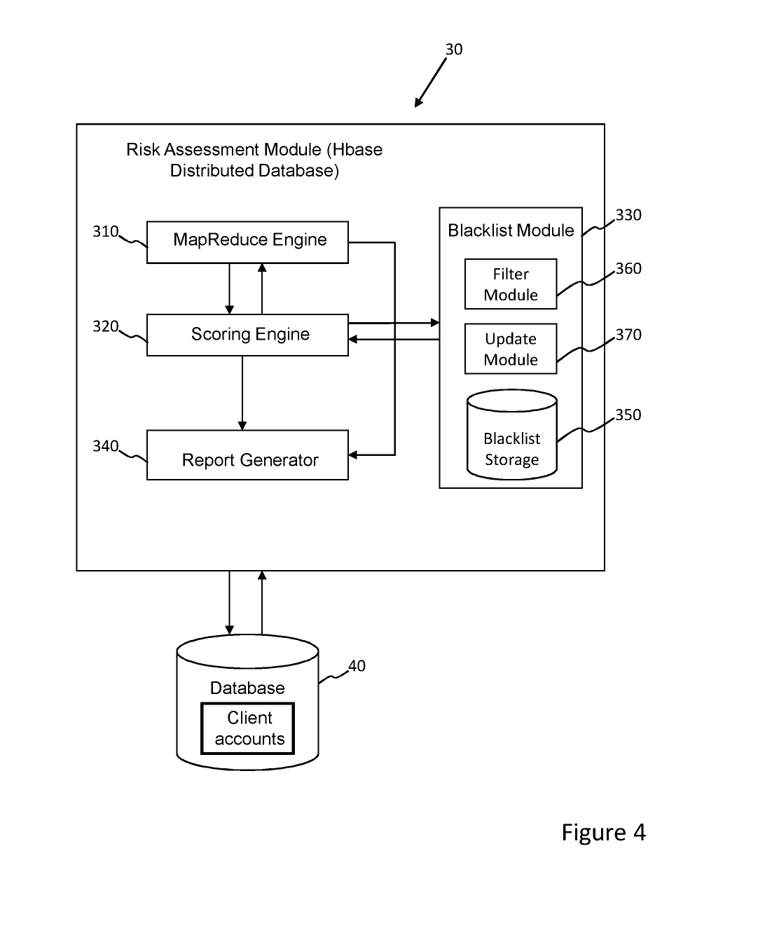

The Risk Assessment Module 30 and the modules it comprises are illustrated in FIG. 4. The Risk Assessment Module 30, which may be an Apache HBase, also uses a MapReduce Engine 310, like the Categorisation Module 20 of FIG. 3, as it is ideal for distributed databases and is connected to the Campaign database 40 containing the client accounts. In the present embodiment, the Risk Assessment Module 30 comprises a Scoring Engine 320 connected to a Blacklist Module 330 and a Report Generator 340, both of which access and use data from the MapReduce Engine 310.

The Blacklist Module 330 is an updatable reference module which stores an active up-to-date, alphabetically ordered list of e-mail addresses which should be viewed with suspicion as it is likely that problems may be caused if an e-mail is sent to such an address. Such problems can, for example, be increased bounce back rates which can lead to blocking by an ISP of all emails from the sending address even if they are not directed to the blacklisted website address.

The Blacklist Module 310 comprises three main elements: namely a Blacklist Storage Module 350, a Filtering Module 360, and an Update Module 370. The Filtering Module 360 allows through all elements (in this case, e-mail addresses) except those explicitly stored in Blacklist Storage Module 350. The Blacklist Storage Module 350 comprises a datastore holding a plurality of blacklisted e-mail addresses. The datastore is updated regularly via the Update Module 370, to ensure that the list of e-mail addresses, to which e-mail should not be sent, is current.

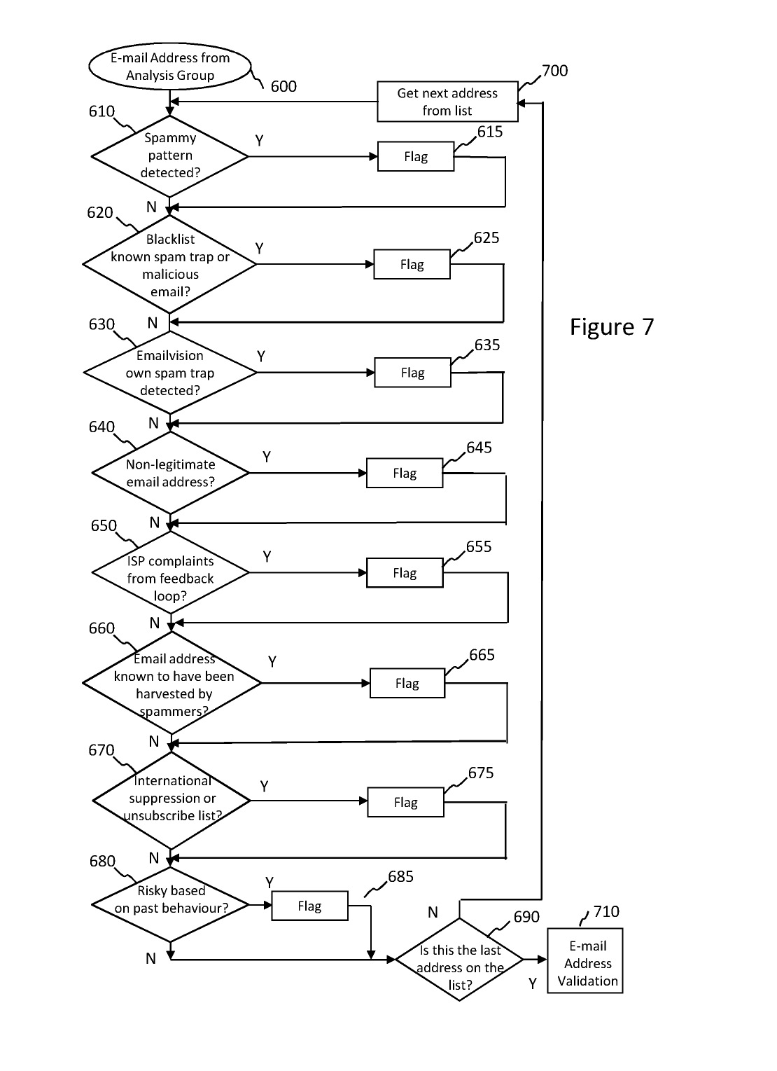

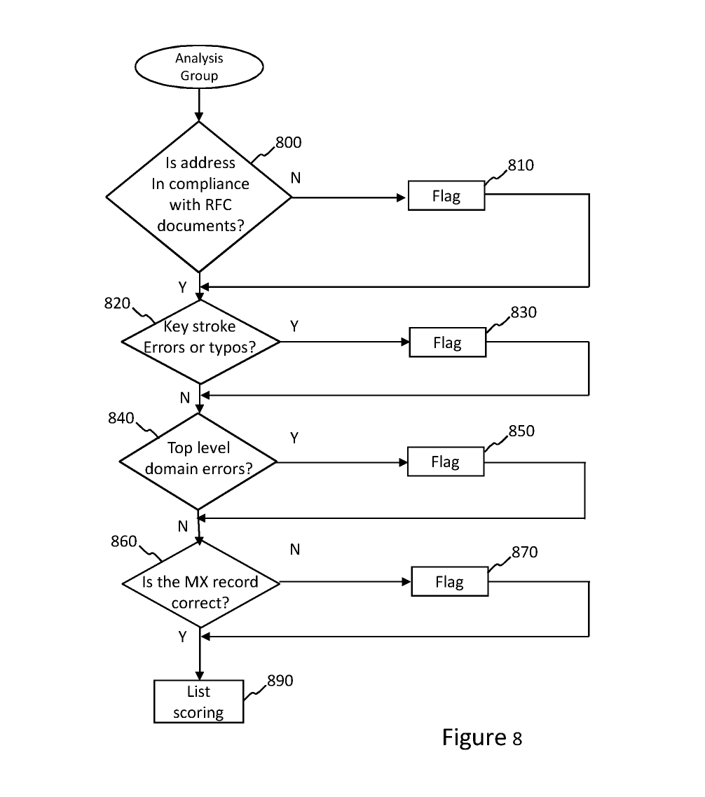

The Scoring Engine 320 associates a risk to each of the addresses flagged by the Categorisation Module 20. The Report Generator 340 calculates the overall risk associated with an e-mail campaign list and generates a report summarising the types of risky patterns and errors flagged by the Categorisation Module 20 of FIG. 3. The functionality of these three Modules will be described in more detail below, with reference to FIGS. 7 and 8.

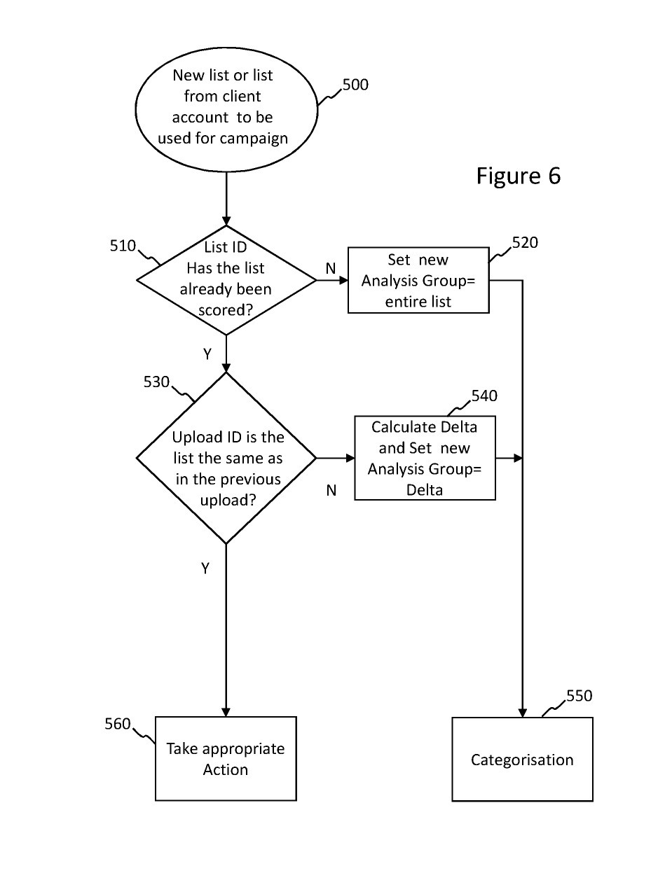

The overview of the Categorisation and Risk Assessment process of FIG. 2, according to an embodiment of the present invention is now described referring to FIG. 5. The Categorisation process 400 begins, at Step 410, with the selection of the e-mail addresses which need to be examined. This can on a first pass be the entire list, but it is typically taken as a subset of the e-mails in the campaign list. The process of selecting the subset will be explained with more detail below, with reference to FIG. 6. The subset of the e-mail campaign list selected will herewith be referred to as the ‘Analysis Group’. The Analysis Group is then alphabetically sorted, at Step 420, and passed, at Step 430, through a risky pattern detection procedure performed by the Risky Pattern Detection Module 220 of FIG. 3. The risky pattern detection procedure involves passing the e-mail campaign list through a series of risky pattern detection filters, as will be explained in more detail below, with reference to FIG. 7. Once all the possibly risky e-mail addresses have been flagged at Step 430, the Analysis Group is then passed, at Step 440, through a series of filters to ensure the e-mail addresses are valid. In this e-mail Address Validation process at Step 440, all the e-mail addresses that are deemed invalid are flagged, as will be explained in more detail below, with reference to FIG. 6.

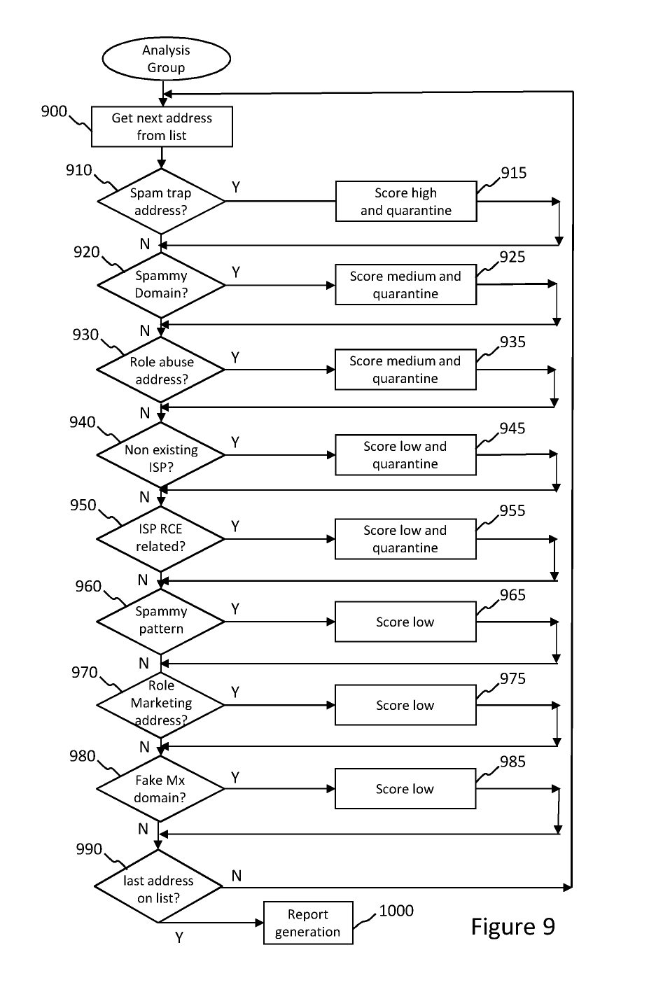

Subsequently, once the screening processes of Steps 430 and 440 have been completed, the Analysis Group is passed, at Step 450, to the Scoring Engine 320 of FIG. 4, where the flagged addresses are given a score depending on the severity of the detected problems in a Risk Assessment procedure 470. The scoring is a means of assessing the risk associated with sending e-mails to each of the flagged addresses. For example, the risk associated with sending an e-mail to an address which is simply misspelled is much lower than the risk associated with sending an e-mail to an address flagged as a known spam trap address. This process will be explained in more detail below, with respect to FIG. 9.

A report is then generated, at Step 460, giving details of each type of invalid e-mail address in the Analysis Group and calculating the cumulative score of the entire list. It should be noted that if the Analysis Group comprises the entire list, then the cumulative score will be calculated for the Analysis Group alone. If, however, the Analysis Group is a subset of the list, then the Analysis Group's score will be calculated, and added to that of the list the Analysis Group originated from. The report generation is performed by the Report Generator 340.

Turning to FIG. 6, the selection of the Analysis Group process begins with a new list input, at Step 500, by the client 1, or an existing list being uploaded from a client account. In both cases the list is identified by way of a List ID (List Identifier—also known as a Campaign Identifier) which is stored in the Categorisation Storage database 240. Also, if an existing list is uploaded it is assigned an upload identifier (Upload ID) and each client is identifiable via a Client Identifier (Client ID). The list is then checked, at Step 510, via cross-referencing its List ID, to determine whether it has already been scored. If the list is found to not have been scored before, then the entire list is set, at Step 520, as the new Analysis Group. If the list is found to have been scored before, then its Upload ID is examined, at Step 530, to determine whether the list has been modified since the previous time it was uploaded (each upload being assigned a unique upload ID). If the upload ID is found, at Step 530, to be different to the previous time the list was uploaded, then the difference between the initial and current versions of the list is calculated. This is deduced by detecting, at Step 540, the different e-mail addresses in the current list and putting these e-mail addresses into a new group to form the Delta, namely the difference between the previous uploaded version of the list and the currently uploaded version. The Delta is set as the new Analysis Group at Step 540.

The new Analysis Group, derived either form Step 520 or Step 540, is then subject, at Step 550, to the Categorisation procedure of FIG. 5.

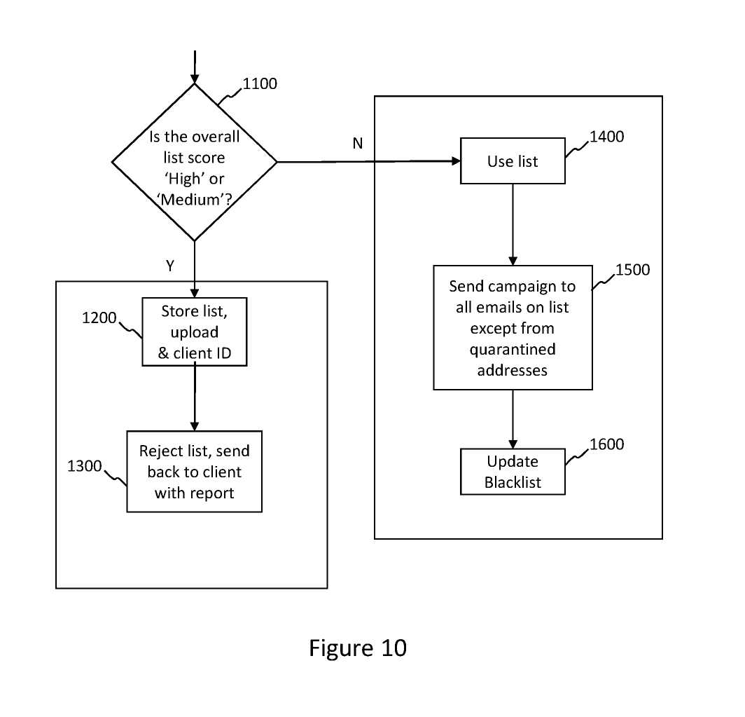

If the Upload ID indicates, at Step 530, that the list has not been modified, the list's previous score is retrieved at Step 560 and it is checked whether the list was categorized as high or medium risk. The appropriate action is taken directly at Step 560 of FIG. 6, rather than going through the categorization and risk assessment procedures 400 and 470. The actual details of the actions taken are described with more detail below, with reference to FIG. 10.

Turning to FIG. 7, a flow diagram of the Risky Pattern Detection Step 430 of FIG. 5 is shown. The process commences with checking, at Step 610, an e-mail address from the input Analysis Group 600 for spammy patterns. These may include known dangerous expressions combined with wildcards, such as %spam%, %idiot%, etc. If the e-mail address is found to contain any of the spammy patterns specified by the process it is flagged at Step 615. The address is then scanned, at Step 620, to see if it matches any of the malicious e-mail addresses and known spam traps, such as ‘abuse©hotmail.com’. If the e-mail address is identified as such it is flagged at Step 625. Subsequently, the address is checked, at Step 630, to see if it matches any of the spam traps set by the list hygiene service, and if so it is flagged at Step 635. Subsequently, if it is detected, at Step 640 that it matches any of the non-legitimate e-mail addresses stored in the Blacklist storage, it is flagged at Step 645. If the e-mail address matches an address which has received feedback loop complaints from ISPs, it is then detected at Step 650 and flagged at Step 655. If it matches an address known to have been harvested by spammers, it is then detected at Step 660 and flagged at Step 665. If the e-mail address matches an address included in international suppression and unsubscribe lists, it is then identified at Step 670 and flagged at Step 675. Subsequently, any patterns which have been identified as risky based on past behavior are detected at Step 680 and flagged at Step 685. Finally, it is checked, at Step 690, whether the e-mail address is the last flagged address in the Analysis Group. If not, the Scoring Engine gets, at Step 700, the next email address from the Analysis Group. If it is, the Analysis Group is then passed, at Step 710, to the E-mail Address Validation Module 230. The e-mail addresses against which the current address of the Analysis Group is checked are referred to as the ‘exact matches’ and can also be combined to form a larger list called the ‘Exact Matches List’. Thus, the ‘Exact Matches List’ comprises of a list of malicious e-mail addresses, a list of known spam traps, a list of e-mail addresses which have received feedback loop complaints, a list of addresses known to have been harvested by spammers, international suppression lists, etc.

For better performance during the Risky Pattern Detection procedure, both the e-mail addresses in the Analysis Group, and the exact matches list are sorted alphabetically. This way, the scoring algorithm doesn't check all e-mail addresses against all exact match rules, which would lead to an O(n2) complexity. Rather, it works using two pointers, one for the Analysis Group list and one for the list it is being checked against, which will herewith be referred to as the list of exact matches. For ease of reference, an order of direction in the alphabetical ordering will be used herewith, from A to Z, with A being referred to as having the highest alphabetical order and Z the lowest. The searching procedure starts with checking the first e-mail address in the Analysis Group List against the addresses in the exact matches list. The searching continues until the first address in the exact match list which has a lower alphabetical order than the target e-mail address of the Analysis Group list is found. This is termed as the ‘end search address’. The pointer of the exact match list is then moved to the exact match e-mail address preceding the ‘end search address’, so that when the second address of the Analysis Group has to be checked against the exact match list, the search only starts from the address preceding the end of search address. This significantly reduces the order of complexity of the algorithm, speeding up the procedure and minimizing the use of computational power. However, it should be noted that it is only used for exact match searches and cannot be used in searches such as that of Step 610, which detects spammy patterns combined with wildcards, as the alphabetical order does not hold.

After all problematic addresses have been identified and flagged at in the process described with reference to FIG. 7, the e-mail address validation process begins, as described below with reference to FIG. 8. Firstly, the syntax of the remaining e-mail addresses of the Analysis Group is checked for compliance with RFC 5322, RFC 5321 and RFC 3696 standards documents at Step 800. If an e-mail address is not in compliance, it is flagged at Step 810. The addresses in the Analysis Group are subsequently examined, at Step 820, for containing key stroke errors and typos. Errors such as ‘Robert©gmail.cm’ or ‘Robert©gmial.com’ are identified at this stage and flagged at Step 830. Subsequently, a top-level domains verification process takes place at Step 840. This process scans for errors of the type ‘.cim’ rather than ‘.com’ or ‘.nett’ rather than ‘.net’, etc. If the address is found to contain any of these errors, it is flagged at Step 850. The mail exchanger (MX) record is then checked at Step 860, to determine whether at least one MX DNS record is associated with the domain part of the e-mail address, so that there is an SMTP server to receive e-mails for the given domain name. If no MX record is associated with the address this is flagged at Step 870. It is to be appreciated that each of these checks may access data provided in the database 40.

Once the Risky Pattern Detection and e-mail Address Validation procedures described with reference to FIGS. 7 and 8 have been completed and all suspicious e-mail addresses have been flagged, the list is passed to the Risk Assessment Module 30 where the Scoring Engine 320 is used to score every flagged e-mail address in the Analysis Group, according to Step 450 of FIG. 5, as illustrated in greater detail in FIG. 9. E-mail addresses can be searched in the entire database using the MapReduce Engine 210 of FIG. 3, thus optimising processing speed. To create a cumulative score for the list, the Scoring Engine 320 matches each e-mail address against the known patterns of the Blacklist Module 330 of FIG. 4, and then calculates the overall score of the list.

The scoring process scores all the flagged e-mail addresses in the Analysis Group depending on their flags, as is best illustrated with reference to FIG. 9 and each flagged e-mail address is checked against every possible pattern and domain error. The process commences with taking the first e-mail address in the Analysis Group at Step 900. First, it is examined, at Step 910, if the flag of the e-mail address is indicating a spam trap address and if so, the e-mail address is given a high score and it is quarantined at Step 915. It should be noted that in this context, the terms high, medium and low score refer to the score given to each address, as opposed to the previously mentioned terms ‘High, ‘Medium’ and ‘Low’ score, which refer to the overall risk of a list. Subsequently, it is examined, at Step 920, whether the address's flag indicates a spammy domain error and if so, the e-mail address is quarantined and is given a medium score, at Step 925. Subsequently, it is examined, at Step 930, whether the e-mail address's flag indicates a role abuse address, and if so, the e-mail address is given a medium score and it is quarantined at Step 935. Then, it is examined, at Step 940, whether the e-mail address's flag indicates non-existing ISP error, and if so, the e-mail address is given a low score and it is quarantined at Step 945. Subsequently, it is examined, at Step 950, whether the e-mail address's flag indicates an ISP RCE related error, and if so, the e-mail address is given a low score at Step 955. Next, it is examined, at Step 960, whether the e-mail address's flag indicates a spammy pattern error, and if so, the e-mail address is given a low score at Step 965. Then, it is examined, at Step 970, whether the e-mail address's flag indicates a role marketing address, and if so, the e-mail address is given a low score at Step 975. Finally, it is examined, at Step 980, whether the e-mail address's flag indicates a fake Mx domain, and if so, the e-mail address is given a low score at Step 985. Subsequently, the Scoring Engine examines, at Step 990, whether the e-mail address was the last in the Analysis Group. If not, the Scoring Engine gets, at Step 900, the next address on the e-mail campaign list. If there are no more e-mail addresses in the list, the Scoring Engine passes, at Step 1000, the Analysis Group to the Report Generation Module.

It should be noted that all the e-mail addresses in the Analysis Group which have not been flagged in the Risky Pattern Detection and the Email Address Validation processes of FIGS. 7 and 8 are not subject to the Scoring process outlined above and are given a 0 score by default. In addition to this, it should be noted that the term ‘quarantine’ refers to a protective measure which has no impact on the scoring of an e-mail address, and therefore in the cumulative e-mail list score. Quarantining involves keeping the problematic address in the e-mail list, but not allowing e-mail to be sent to that address, as mentioned below, with reference to FIG. 10.

After all the addresses on the Analysis Group have been scored, the Analysis Group is passed to the Report Generator 340, where the cumulative score of the list is calculated and the list report is generated at Step 1000.

As illustrated in the flow diagram of FIGS. 9 and 10, the overall score of the list is calculated, at Step 1000. In the case where the Analysis Group represents the entire list, this involves simply calculating the cumulative score of the Analysis Group. If, however, the Analysis Group represents a subset of a previously scored list, then the overall score of the list is calculated by adding that of the Analysis Group to that of the previously scored list. Subsequently, a report is generated, at Step 1000, for the entire list. The report contains a summary of how many errors of each category were found and the overall score of the list.

Once the report has been generated, it is checked, at Step 1100 whether the corresponding list's score is “High” or “Medium”. If so, the list's Client ID, List ID and Upload ID are stored for future reference at Step 1200 and the list is rejected and returned to the client, together with the report, at Step 1300. The list is then sent back to the client, at Step X, together with the report.

If the list's overall score is found, at Step 1100, to be ‘Low’, the list is used for the campaign, at Step X. The list is used to send out e-mails in an e-mail campaign, at Step 1500, to all the e-mail addresses apart from those quarantined during the scoring of FIG. 9.

Once the campaign has been sent, all the bounce messages received back for undeliverable e-mails are used, at Step 1600, to update the Blacklist stored in the Blacklist Module.

The term bounce message refers to the Non-Delivery Report (DNR), Delivery Status Notification (DSN) or non-Delivery Notification (NDN), informing the sender about a delivery problem. The bounce messages or bounces can be distinguished in ‘soft’ and ‘hard’ bounces. ‘Soft’ bounces are received for e-mail messages that use a valid e-mail address and make it as far as the recipient's mail server but are bounced back undelivered before getting to the recipient.

‘Hard’ bounces are received when a message is permanently undeliverable. This can be due to various causes, such an invalid recipient address or a mail server which has blocked the sender.

Soft bounces are generally considered less harmful and are given a low or medium score, whereas hard bounces are generally given a high score.

In addition to this, the Blacklist can also be updated manually and automatically on a regular basis, based on the data activity of the used e-mail addresses. For instance, should an e-mail be sent to an address and not be opened for three months, then the lack of tracking activity is reported to the Blacklist Module, which updates the risk profile of the address in the Blacklist storage to a high or medium score accordingly.

Having described several embodiments of the present invention, it is to be appreciated that the present invention is not limited to the embodiments described above and is to include variations and modifications that will become apparent to the skilled addressee which fall within the scope of the appended claims.

1. A computer-implemented method of assessing the veracity of a list of email addresses for use with an e-mail messaging campaign, the method comprising:
receiving the list of email addresses;
categorizing and marking any email addresses from the received list of email addresses which are considered to have predetermined email address problems; each marked email address being assigned a category of problem;
associating each marked email address with a score, wherein the score is dependent on the severity of risk associated with the assigned category;
calculating a cumulative score of all of the marked email addresses;
determining, in view of the cumulative score of the marked email addresses, whether the list of email addresses is safe for use for the email messaging campaign.

2. The method of claim 1, wherein the receiving step comprises uploading a large list of email addresses.

3. The method of claim 1, wherein the categorizing and marking step comprises selecting an analysis group of email addresses from a plurality of email addresses provided in the list of email addresses.

4. The method of claim 3, wherein the selecting step comprises selecting a subset of the email addresses provided in the list of email addresses and the method further comprising ordering the selected analysis group of email addresses into alphabetical order.

5. (canceled)

6. The method of claim 3, wherein the categorizing and marking step comprises comparing a composition of each email in the selected analysis group against one or more composition patterns associated with a risky email address and marking the email if the composition of the email address matches a known risky composition pattern.

7. The method of claim 6, wherein the comparing step comprises using a plurality of different risky pattern detection filters.

8. The method of claim 7, wherein the using step comprises selecting at least one of the risky pattern detection filters from the group comprising: a spammy pattern detection filter; a spam trap address filter; a malicious email address filter; a sender's own spam trap filter; a non-legitimate email address filter; an ISP complaints from feedback loop filter; a harvested-by-spammers filter; an unsubscribe list filter; an international suppression list filter and a risky historical behaviour filter.

9. The method of claim 7, wherein each filter comprises a pattern list of email address patterns and the comparing step comprises comparing each email address of the selected analysis group against the email address patterns of the pattern list for an exact match.

10. The method of claim 9, wherein the email address patterns of the pattern list are stored in alphabetical order and the email addresses of the analysis group are stored in alphabetical order and the method further comprises comparing an email address of the analysis group from a start pointer within the pattern list until an end email address pattern is reached which is beyond the alphabetical value of the email address being compared.

11. The method of claim 10, further comprising moving the start pointer of the pattern list to the email address pattern preceding the end email address pattern and repeating the comparing step for the next email address of the analysis group.

12. The method of claim 3, wherein the analysis group has a current email address pointer and the method further comprises incrementing the position of the current email address pointer to point to the current email address in the analysis group being considered.

13. The method of claim 3, wherein the categorizing and marking step further comprises checking each email address in the analysis group for syntax errors, and the checking step comprises checking each email address of the analysis group for common or obvious errors in the email addresses by comparing the email address against a predetermined list of common and obvious syntactical errors.

14. (canceled)

15. The method of claim 1, wherein the associating step comprises providing for each category of problem, a corresponding predetermined score, and assigning the corresponding score to each marked email address associated with a predetermined email address problem.

16. The method of claim 15, wherein the associating step comprises assigning for each category of problem that applies to a marked email address the corresponding predetermined score and storing a cumulative score of all of the applicable predetermined scores.

17. (canceled)

18. The method of claim 1, wherein the associating step comprises determining whether the marked email address has one of the problems of the group comprising: a spam trap address; a spammy domain; a role abuse address; a non-existing ISP address; an ISP RCE restricted address; a spammy pattern address; a role marketing address and a fake MX domain address.

19. The method of claim 1, wherein the associating step comprises providing a subset of the categories of problem with a quarantine flag indicating that the email address should not be used currently in the email messaging campaign and the assigning step comprises assigning the quarantine flag if marked email address relates to a category of problem from the subset.

20. The method of claim 1, further comprising generating a report regarding the email addresses in the list and the associated scores applied to the marked email addresses and sending the report to a known client address associated with the email messaging campaign.

21. (canceled)

22. The method of claim 1, wherein the determining step comprises assessing whether the cumulative score of the email address list is within a high or medium score range and if the cumulative score is within the medium or high range, rejecting the entire email address list as unsafe to use for the email messaging campaign.

23. The method of claim 1, wherein the determining step comprises assessing whether the cumulative score of the email address list is within a high or medium score range and if the cumulative score is not within the medium or high range, accepting the entire email address list as safe to use for the email messaging campaign.

24. The method of claim 23, wherein the accepting step comprises accepting the entire email address list as safe to use for the email messaging campaign except for any quarantined email addresses having a quarantine flag assigned.

25. (canceled)

26. The method of claim 1, further comprising assigning an upload identifier to each instance of a received list, assigning a client identifier to identify an owner of the email address list; and assigning a campaign identifier to identify each email messaging campaign to which the list belongs, and using the identifiers to determine if a current email address list for the same client and the same campaign is received in the receiving step which has a different upload identifier and for this current list calculating differences between the email addresses of the current list and a previous email address list for the same client and campaign.

27. (canceled)

28. The method of claim 26, wherein the categorizing and marking step comprises selecting a difference analysis group of email addresses from the differences determined in the using step.

29. A computer-based verification system for assessing the veracity of a list of email addresses for use with an e-mail messaging campaign, the system comprising:
one of more computer readable storage devices configured to store a plurality of computer executable instructions; and
one of more hardware computer processors in communication with the one of more computer readable storage devices and configured to execute a plurality of computer executable instructions in order to cause the system to:
receive the list of email addresses;
categorize and mark any email addresses from the received list of email addresses which are considered to have predetermined email address problems; each marked email address being assigned a category of problem;
associate each marked email address with a score, wherein the score is dependent on the severity of risk associated with the assigned category;
calculate a cumulative score of all of the marked email addresses; and
determine in view of the cumulative score of the marked email addresses, whether the list of email addresses is safe for use for the email messaging campaign.
